(19) United States
(12) Patent Application Publication
(10) Pub. No.: US 2015/0371250 A1
(43) Pub. Date: Dec. 24, 2015

(54) METHOD AND APPARATUS FOR PROMOTING SALES AND INCREASING BRAND NAME RECOGNITION

(71) Applicant: Errol DORIS, (US)

(72) Inventor: Errol S. DORIS, SR., Countryside, IL (US)

(21) Appl. No.: 14/421,229

(22) PCT Filed: Mar. 13, 2014
(86) PCT No.: PCT/US14/26610

§ 371 Date: Feb. 12, 2015

Related U.S. Application Data
(60) Provisional application No. 61/781,461, filed on Mar. 14, 2013.

(51) Int. Cl. G06Q 30/02

(52) U.S. Cl. CPC G06Q 30/0212; G06Q 30/0255

(57) ABSTRACT

A method for promoting sales and increasing brand recognition is provided, the method comprising: selecting brand names of products based on customer purchases enumerated on a customer receipt generated at a retail outlet; obfuscating one of said brand names on the customer receipt so as to induce a customer to attempt to guess the one of said brand name; and determining if the customer guessed correctly. Also provided is a brand-name promotional system, the system comprising a point of sale scanner for recording customer purchases at a retail outlet, a protocol for identifying product classes based on the customer purchases; game piece generator for printing indicia onto a customer receipt; wherein the indicia is an obfuscated brand name, wherein the brand name identifies goods found in the product classes; and a protocol for determining if a customer correctly guesses the brand name from the indicia.

### PRIORITY

This application claims the benefits of priority as the nationalization of international application PCT/US2014/026610, currently pending, filed on Mar. 13, 2014 which in turn claimed the priority benefit of U.S. Provisional Application No. 61/781,461 filed on Mar. 14, 2013, currently expired, the entirety of which is incorporated herein by reference.

### BACKGROUND OF THE INVENTION

1. Field of the Invention

This invention relates to a method for promoting brands at point of sale scenarios, and more specifically, the invention uses cash register receipts and coupons as promotion vehicles for various well-known brand names.

2. Background of the Invention

Brick and mortar retailers process in access of 45 billion cash register transactions each year. There are more than 310,000 cash registers at these retailer locations in the United States.

Millions of stock keeping units (SKUs) vie for shelf space in stores all over the world; all in an effort to expand brand recognition and therefore sales. Retail chain stores average about 45,000 SKU's per location. However, only so much space is available in typical brick and mortar retail outlets. The average Big Box retailer stocks an inventory of between 90,000 and 120,000 items in warehouses. These items are sold exclusively by internet.

A need exists in the art for a vehicle to expand brand exposure without concomitant increase in allocation of shelf space. The vehicle should be visible to every purchaser visiting brick and mortar establishments. The vehicle should also engage the purchaser and ideally leverage that purchaser's penchant for certain products.

### SUMMARY OF INVENTION

An object of the invention is to provide cost effective brand exposure in brick and mortar establishments that may overcome many of the disadvantages of the prior art.

Another object of the present invention to provide a method for pre-selling revenue futures to retailers. A feature of the invention is the use of cash register receipts to leverage a purchaser's preference for certain products. An advantage of the invention is that retailers share in advertising proceeds that are generated when the cash register receipt is used as an advertising vehicle.

Still another object of the present invention is increasing advertising through purchaser incentives and participation. A feature of the invention is using point of sale advertising vehicles identifying buyer preferences to induce customers to participate in a contest. An advantage of the invention is that point of sale vendor support is provided in exchange for creating an attractive audience for brand managers of those retail outlets.

Yet another object of the present invention is to increase exposure of customer-preferred advertised brands by utilizing a fast response customer experience via a smart phone and other intelligent devices. To facilitate this use, the customer will utilize an “app” linking to a web portal displaying a game play incentive program that uses the brand names as features of the game play.

Briefly, the invention provides a method for promoting sales and increasing brand recognition, the method comprising selecting brand names of products based on customer purchases enumerated on a customer receipt, wherein a specific alpha-numeric sequence appears on that receipt; obfuscating one of said brand names on the customer receipt so as to induce a customer to attempt to guess the one of said brand name; and determining if the customer guessed correctly. Each winning is determined by the customer logging on to a web portal and entering the special code displayed on the cash register receipt.

Also provided is a brand-name promotional system, the system comprising a means (e.g. a scanner) for recording customer purchases at a retail outlet; means for categorizing product classes based on the customer purchases; game piece generator for printing indicia onto a customer receipt; wherein the indicia is an obfuscated brand name found in the product classes; and means for determining if a customer correctly guesses the brand name from the indicia. The system also provides a method to retrieve the customer's winning remotely, for example via a web portal.

### BRIEF DESCRIPTION OF DRAWING

The invention together with the above and other objects and advantages will be best understood from the following detailed description of the preferred embodiment of the invention shown in the accompanying drawings, wherein:

FIG. 1 depicts a schematic flow chart of a brand name promotion process, in accordance with features of the present invention;

FIGS. 2A-B depict exemplary game pieces for use in a point of sale promotional game, in accordance with features of the present invention; and

FIG. 3 is a splash screen of an internet embodiment of a brand name guessing game incorporated in the invented method, in accordance with features of the present invention.

### DETAILED DESCRIPTION OF THE INVENTION

The foregoing summary, as well as the following detailed description of certain embodiments of the present invention, will be better understood when read in conjunction with the appended drawings.

To the extent that the figures illustrate diagrams of the functional blocks of various embodiments, the functional blocks are not necessarily indicative of the division between hardware circuitry. Thus, for example, one or more of the functional blocks (e.g. processors or memories) may be implemented in a single piece of hardware (e.g. a general purpose signal processor or a block of random access memory, hard disk or the like). Similarly, the programs may be stand-alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and preceded with the word “a” or “an” should be understood as not excluding plural said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

The invented method controls promotion of various products. The method provides a means for revenue building for retailers from their existing vendor bases. A cornerstone of the method is to induce cash receipt holders (i.e., purchasers of goods) to utilize the cash receipt as a game piece. An exemplary inducement is to associate the cash receipt with a popular board game, such as Brandoodles. In an embodiment of the method, the cash receipt displays the board game name in its familiar logo type.

Retail outlets are suitable venues for practicing the method. Exemplary retailer types include home improvement stores, supermarkets, grocery stores, pharmacies, general stores, electronic stores, computer stores, variety goods stores, department stores, and club membership stores. In 2012, these retailers executed more than 45 billion cash transactions at over 47,000 locations, each with an average of nine point-of-sale (POS) cash registers or terminals.

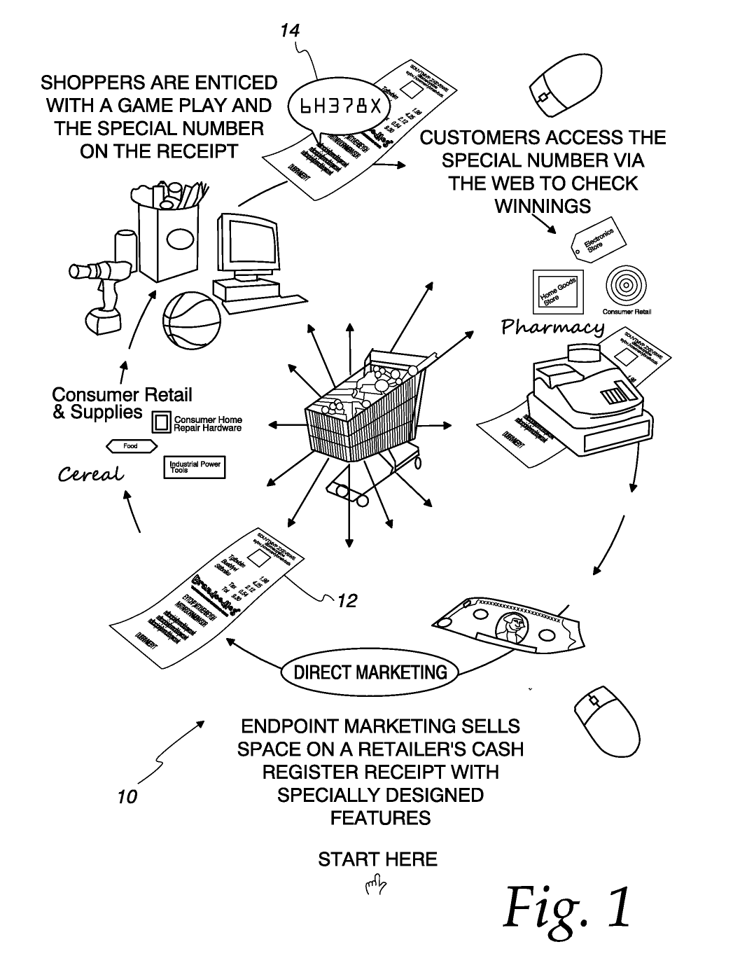

FIG. 1 is a schematic depiction of the invented method, the method designated as numeral 10. A first step in the method is to produce a cash register receipt with printed indicia 12. In one embodiment, the indicia will be specific for the purchaser's type of goods bought. In another embodiment, the indicia will have no bearing on any of the current goods purchased and will not be based on the class of goods just purchased. However, in another embodiment indicia is specific to type of store where the receipt was printed and in other embodiments, the “class” of goods will be reflected in the indicia. For example, in use of this embodiment in a supermarket setting, there are three classes: (a) food/beverage (b) health & beauty (c) household. The home improvement store uses three exemplary classes as well (a) tools (b) hardware (c) appliances. Typically with a promotional coupon program, no one provides incentive at the point of sale with immediate savings, the coupon provider incentives the customer to make a return store visit that day, or another day, or online, to purchase the items promoted.

Aside from the standard printed data on the receipt, such as items bought, price, tax, return policies, etc., the receipt will include two unique additions which transforms it into a game piece. First, the receipt will have an obfuscated version of a brand name the purchaser has seen before. In an embodiment of the invention, the brand name is selected based on the database established for that particular purchaser. In another embodiment of the invention, both the retailer and the advertiser is responsible for populating the database.

Second, the receipt will also have a number string, word string, or an alpha-numeric string 14. Ostensibly, this second indicia will allow purchasers access to a website to check their winnings when they have attempted guessing the brand name from the obfuscated version of the brand name on their cash receipt. However, the second indicia will, just as importantly, originate from a plurality of unique identifier strings associated with a brand name guessing game, for example the Brandoodles board game. The board games come in both virtual and hardcopy form. Virtual ones allow the board game to be structured toward the individual purchaser's buying preferences, and the database of that purchaser's repeated purchases and visitations to the website.

Generally, the game is developed in different media forms. For example, as an embodiment in a board games such as Brandoodles, which is owned by BELCOM CORP. of Chicago, Ill., and comprises a brand name guessing game.

Another embodiment comprises a television game show. In this embodiment, the audience utilizes a smart phone or intelligent device to participate onsite or remotely from the show venue.

Yet another embodiment is an online version of a well-known board game, such as Brandoodles. A multi-faceted web portal hosts the player access portal. Retrieval of winnings occurs by means of coupons or codes based on historical data maintained by advertisers and retailers. That data is retrieved and applied to the on-line interaction via a standard data link. The database of advertised products is further determined and modified as part of the progression of the game.

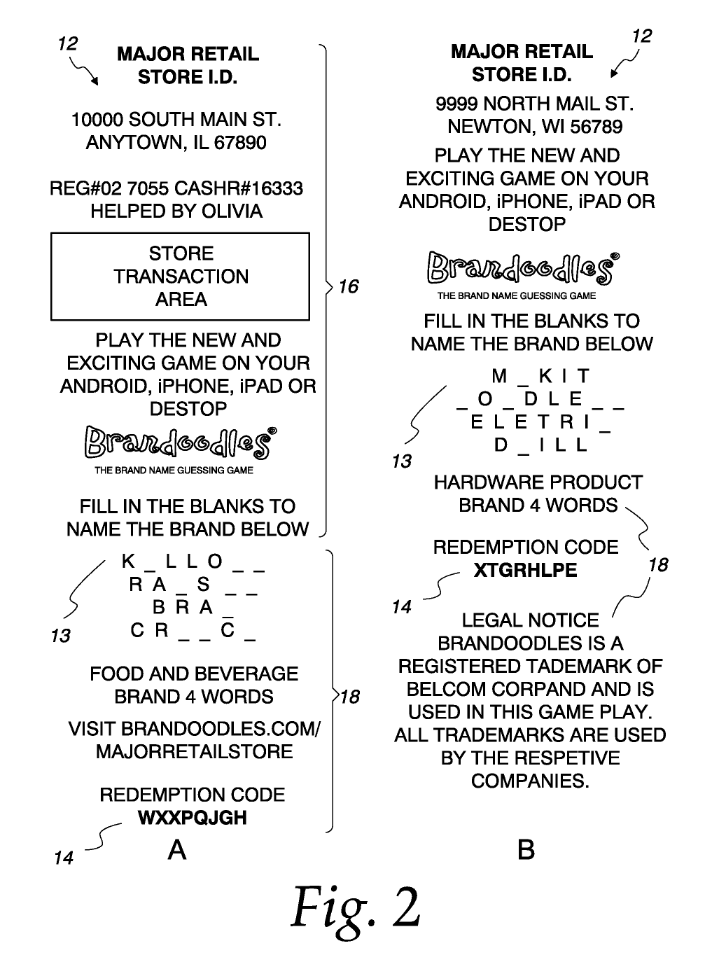

FIGS. 2A and B are schematic diagrams of exemplary cash register receipt/game pieces 12. A top portion 16 contains typical purchase details and return policy details. A bottom portion 18 of the cash register receipt 12 contains the aforementioned two unique additions which transforms the receipt into the game piece. The first game piece contains the obfuscated brand name 13. In the example depicted in FIG. 2A, the brand name is KELLOGS RAISEN BRAND CRUNCH, and therefore an appropriate genre for the type of store (e.g. a food store) which generates the particular cash register receipt. FIG. 2B contains the obfuscated brand name 13 MAKITA CORDLESS ELECTRIC DRILL which would be an appropriate genre for the type of store (e.g., hardware or handyman store) that generates such a cash register receipt.

The second edition is the aforementioned number string, word string or alpha-numeric string 14. The specific alpha-numeric string depicted (6H378X) is for illustrative purposes only and not intended to limit the invention to this symbol sequence. In one embodiment, the system employs commercially available software to generate millions of randomly generated strings. The association of the alpha-numeric string and Brandoodles is based on (a) the assignment of select alphanumeric codes that is assigned a specific value by an administrator account, such as administrator@brandoodles.com in one embodiment and (b) the pre-sale of a bucket of codes being sold by the administrator@brandoodles.com to the advertiser and/or the retailer for the purpose of participation. The codes can be generated using a string generation software, such as an online string generator found in several locations such as at the sweepjudge.com string generator, the source code of which is attached hereto as Appendix B.

In operation, a game administrator (e.g., a licensee of the invented process) charges advertisers (e.g. brand managers) a fee to advertise their brand name on a cash register. The retail outlet is charged a few hundreds of a U.S. cent as a “click charge” to access this revenue generator. The retailers agree to use the face of their cash register as a portal to the process. The retailers and brand managers make product selections, and determine the number of stores involved and the duration of involvement.

The game administrator manages the pre-sells (e.g., the aforementioned click charges) and generates the random numbers 14 appearing on the cash register receipts. A method for transferring the random numbers is for the administrator to load them into the retailer- or brand manager's headquarter-database.

The game administrator then converts the pre-sold number 14 to game play. Winning numbers are preselected. In an embodiment of the invention, a brand manager pre-selects groups of the winning numbers according to an algorithm that generates the numbers according to the odds of winning. In this case, everyone becomes a winner. For example, if 1000 products are preselected to be displayed, the odds shall be designated according to a discounting process, given the distribution sample as follows:

| 30 | 50 | 70 | 90 | 110 | 130 | 150 | 170 | 200 |
|---|---|---|---|---|---|---|---|---|
| wins | wins | wins | wins | wins | wins | wins | wins | wins |
| 90% | 80% | 70% | 60% | 50% | 40% | 30% | 20% | 10% |

Therefore, if a Retailer sold a product for $20, 30 wins at a 90% discount would be $18 off the price at which the buyer would only pay $2. The Buyer would receive a retrieval code with a value of $18 at redemption. Likewise, 200 wins at a 10% discount, the Buyer would receive a discount of $2 off the price at which the buyer would pay $18 at redemption.

Hence, if the Seller is an Automotive Dealer selling a big ticket item such as a Chevrolet Cruze with a list price of $17,130, the administrator has the option to change the algorithm according to the expected giveaway value, as follows:

| 3 | 5 | 7 | 15 | 30 | 40 | 200 | 300 | 400 |
|---|---|---|---|---|---|---|---|---|
| wins | wins | wins | wins | wins | wins | wins | wins | wins |
| 90% | 80% | 70% | 60% | 50% | 40% | 30% | 20% | 10% |

In this case 3 wins at a 90% discount would save $15,417 and 400 wins at a 10% discount would save $1,730 which would be redeemed with a code at the time of purchase.

When reconciled by the winner shopper, the winner is linked to the administrator's website which in turn notifies the retailer and/or brand manager of the existence of the winner. Auditing procedures are established to confirm winner versus loser rates. In one embodiment, the exclusive game administrator is administrator@brandoodles.com. In another embodiment of the invention, both the administrator's website and the retailer's website (and perhaps the brand manager's website) are notified of the existence of a winner.

The invented method and system for promoting brand names is based on incentive. Retail outlet customers are induced to play the game embodied on their cash receipt/game piece when they see a well-known logo of a brand name guessing game.

Retailers are induced to participate in the invented method and system inasmuch as some of the advertising proceeds are funneled back to the retail outlets.

### EXAMPLE

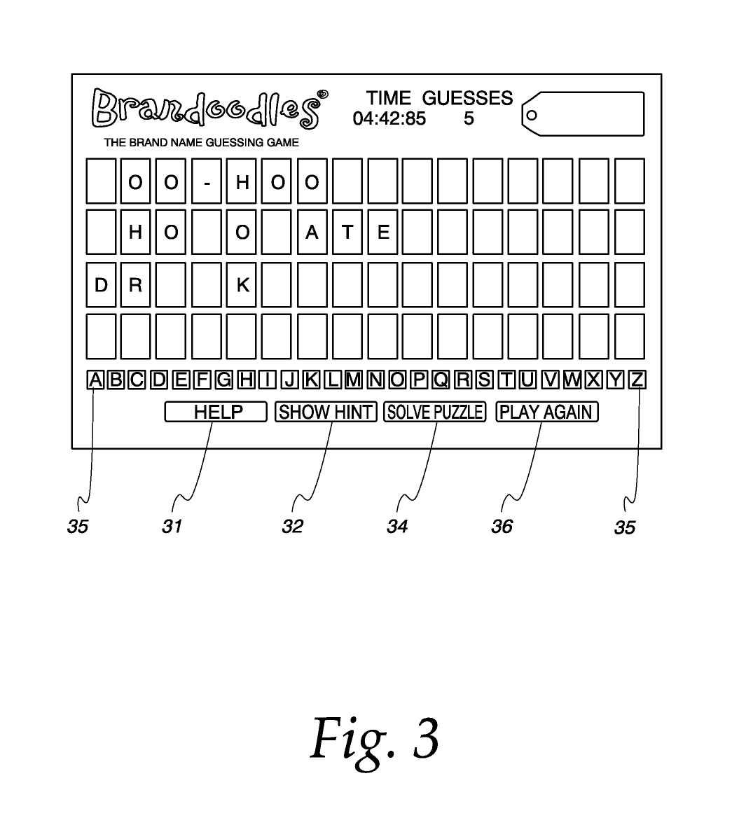

Users of the invention can access commercially available copies of the Brandoodles game system, or similar system at several game stores or outlets via a web search or physical search of “big box” retail locations. For example, the latest electronic form of an embodiment of the invention can be found online and depicted in FIG. 3. The source code of the splash screen (FIG. 3) of this web based embodiment is included below as Appendix A. The screen features a plurality of play toggles 31-36 the toggles designed to actuate the game. A panel 35 of letters is provided to allow the user to try and guess the letters associated with the brand name depicted.

The Player's board is an interactive platform that will generate hash algorithm applications of alpha characters based on a random generator with a fixed or variable value. The fixed value may be 26—representing the number of letters in the English alphabet. The fixed value may be 30—representing the number of letters in the Spanish alphabet. The fixed value may be variable with different languages with additional subsets of characters. Hence, If the brand in question being used is designated as having four words, a brand example may be: TROPICANA PREMIUM ORANGE JUICE. This brand possesses 4 words with 30 characters, the game piece generator may produce a possible (26)⁴ power or a possible randomization of 456,976 combinations of words revealed on each surface that the game is being played, such as the Actual Final Result shown:

| | | | | | | | | |
|---|---|---|---|---|---|---|---|---|
| T | R | O | P | I | C | A | N | A |
| P | R | E | M | I | U | M | | |
| O | R | A | N | G | E | | | |
| J | U | I | C | E | | | | |

The Random Generator would show each result differently as shown on each surface such as:

| | | | | | | | | |
|---|---|---|---|---|---|---|---|---|
| T | | O | | I | C | | N | A |
| | R | | M | | U | M | | |
| O | R | | N | | E | | | |
| | | I | C | E | | | | |

And again in every instance as shown here:

| | | | | | | | |
|---|---|---|---|---|---|---|---|
| T | | O | P | | | A | A |
| P | | E | | I | U | M | |
| O | | A | | G | E | | |
| J | U | | C | | | | |

The uniqueness of this generation is that no two game sets will appear alike on any surface of the smart phone, computer or other intelligent device, hence, the randomization will also apply to the output on every cash register receipt as different.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting, but are instead exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the terms “comprising” and “wherein.” Moreover, in the following claims, the terms “first,” “second,” and “third,” are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

The present methods can involve any or all of the steps or conditions discussed above in various combinations, as desired. Accordingly, it will be readily apparent to the skilled artisan that in some of the disclosed methods certain steps can be deleted or additional steps performed without affecting the viability of the methods.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” “more than” and the like include the number recited and refer to ranges which can be subsequently broken down into subranges as discussed above. In the same manner, all ratios disclosed herein also include all subratios falling within the broader ratio.

One skilled in the art will also readily recognize that where members are grouped together in a common manner, such as in a Markush group, the present invention encompasses not only the entire group listed as a whole, but each member of the group individually and all possible subgroups of the main group. Accordingly, for all purposes, the present invention encompasses not only the main group, but also the main group absent one or more of the group members. The present invention also envisages the explicit exclusion of one or more of any of the group members in the claimed invention.

APPENDIX A
Source Code for Web-based Embodiment

<html>
<head>
<meta http-equiv=“Content-Type” content=“text/html; charset=utf-8”>
<!-- GOOD FOR SEO -->
<meta name=“description” content=“”>
<meta name=“keywords” content=“”>
<meta name=“copyright” content=“Copyright © 2011 YourWebsite.com”>
<meta name=“author” content=“Your Name”>
<meta name=“designer” content=“Your Name”>
<meta name=“email” content=“contact@email.com”>
<meta name=“robots” content=“index, follow”>
<meta name=“googlebot” content=“index, follow”>
<meta name=“revisit-after” content=“1 Day”>
<meta name=“rating” content=“General”>
<meta name=“distribution” content=“Global”>
<!-- GOOGLE VERIFY -->
<meta name=“google-site-verification” content=“XXX-XXX-XXX” />
<!-- ICON FAVI -->
<link rel=“icon” type=“image/x-icon” href=“images/favicon.png”>
<link rel=“shortcut icon” type=“image/x-icon” href=“images/favicon.png”>
<!-- FACEBOOK META SHARE -->
<meta property=“og:title” content=“” />
<meta property=“og:type” content=“website” />
<meta property=“og:url” content=“http://yourwebsite.com” />
<meta property=“og:image”

content=“http://yourwebsite.com/images/facebookimage.png” />

<meta property=“og:site_name” content=“” />
<meta property=“og:description” content=“” />
<!-- TITLE OF WEBSITE -->
<title>Brandoodles on HTML</title>
<!-- WEBSITE SCRIPT & SOURCE -->
<link rel=“stylesheet” href=“css/reset.css”>
<link rel=“stylesheet” href=“css/style.css”>
<link rel=“stylesheet” href=“css/jquery-ui-1.8.21.custom.css”>
<script src=“js/jquery.1.7.2.min.js” type=“text/javascript”></script>
<script src=“js/jquery-ui-1.8.21.custom.min.js”
type=“text/javascript”></script>
<script src=“js/jquery.global.js” type=“text/javascript”></script>
<script src=“js/test.js?1363119143” type=“text/javascript”></script>
<script src=“greensock/minified/TweenMax.min.js”
type=“text/javascript”></script>
<script type=“text/javascript“ src=“js/jquery.timer.js”></script>
<script type=“text/javascript“ src=“js/timer.js”></script>
<script>
$(function( ) {

var options = {

letterWidth: 40,

```
  guess: 7,
  hint: 1,
  data:
```

{“1_1”:{“text”:“”,“solution”:“Y”,“x”:1,“y”:1},“1_2”:{“text”:“o”,“solution”:“o
”,“x”:2,“y”:1},“1_3”:{“text”:“o”,“solution”:“o”,“x”:3,“y”:1},“1_4”:{“text”:“-
”,“solution”:“-
”,“x”:4,“y”:1},“1_5”:{“text”:“H”,“solution”:“H”,“x”:5,“y”:1},“1_6”:{“text”:“o
”,“solution”:“o”,“x”:6,“y”:1},“1_7”:{“text”:“o”,“solution”:“o”,“x”:7,“y”:1},“
2_1”:{“text”:“”,“solution”:“C”,“x”:1,“y”:2},“2_2”:{“text”:“h”,“solution”:“h”,
“x”:2,“y”:2},“2_3”:{“text”:“o”,“solution”:“o”,“x”:3,“y”:2},“2_4”:{“text”:“”,“
solution”:“c”,“x”:4,“y”:2},“2_5”:{“text”:“o”,“solution”:“o”,“x”:5,“y”:2},“2_6
”:{“text”:“”,“solution”:“1”,“x”:6,“y”:2},“2_7”:{“text”:“a”,“solution”:“a”,“x”
:7,“y”:2},“2_8”:{“text”:“t”,“solution”:“t”,“x”:8,“y”:2},“2_9”:{“text”:“e”,“so
lution”:“e”,“x”:9,“y”:2},“3_1”:{“text”:“D”,“solution”:“D”,“x”:1,“y”:3},“3_2”:
{“text”:“r”,“solution”:“r”,“x”:2,“y”:3},“3_3”:{“text”:“”,“solution”:“i”,“x”:3
,“y”:3},“3_4”:{“text”:“”,“solution”:“n”,“x”:4,“y”:3},“3_5”:{“text”:“k”,“solut

| | |
|---|---|
| ion”:“k”,“x”:5,“y”:3}} | }; |

$(‘#branArea’).Brandle(options);

});

function replay( ) {

//$(‘#branArea’).html(‘’);
var options = {

letterWidth: 40,

```
  guess: 7,
  hint: 1,
  data:
```

{“1_1”:{“text”:“V”,“solution”:“V”,“x”:1,“y”:1},“1_2”:{“text”:“i”,“solution”:“
i”,“x”:2,“y”:1},“1_3”:{“text”:“v”,“solution”:“v”,“x”:3,“y”:1},“1_4”:{“text”:“
”,“solution”:“a”,“x”:4,“y”:1},“1_5”:{“text”:“”,“solution”:“r”,“x”:5,“y”:1},“1
_6”:{“text”:“i”,“solution”:“i”,“x”:6,“y”:1},“1_7”:{“text”:“n”,“solution”:“n”,
“x”:7,“y”:1},“2_1”:{“text”:“”,“solution”:“C”,“x”:1,“y”:2},“2_2”:{“text”:“”,“s
olution”:“a”,“x”:2,“y”:2},“2_3”:{“text”:“f”,“solution”:“f”,“x”:3,“y”:2},“2_4”
:{“text”:“f”,“solution”:“f”,“x”:4,“y”:2},“2_5”:{“text”:“”,“solution”:“e”,“x”:
5,“y”:2},“2_6”:{“text”:“i”,“solution”:“i”,“x”:6,“y”:2},“2_7”:{“text”:“n”,“sol
ution”:“n”,“x”:7,“y”:2},“2_8”:{“text”:“”,“solution”:“e”,“x”:8,“y”:2},“3_1”:{“
text”:“P”,“solution”:“P”,“x”:1,“y”:3},“3_2”:{“text”:“i”,“solution”:“i”,“x”:2,
“y”:3},“3_3”:{“text”:“”,“solution”:“l”,“x”:3,“y”:3},“3_4”:{“text”:“”,“solutio
n”:“l”,“x”:4,“y”:3},“3_5”:{“text”:“s”,“solution”:“s”,“x”:5,“y”:3}}
};

$(‘#branArea’).Brandle(options);
//clock.resetCountdown( );

}
function showError( ) {
var failure = document.getElementById(“failure”);
TweenLite.fromTo(failure, 1, {top: 0, left: 210}, {top: 80, left:

210, ease: Back.easeInOut, onComplete: closeError});

}
function showSuccess(num) {

var success = document.getElementById(“success”);

success.innerHTML = “<p style=‘font-size: 40px;padding-

top:100px;padding-left:50px;font-family: Arial’>There are “+num+” letter in
the puzzle...</p>”;

TweenLite.fromTo(success, 1, {top: 0, left: 210}, {top: 80, left:

210, ease: Back.easeInOut, onComplete: closeSuccess});

}
function closeError( ) {

var failure = document.getElementById(“failure”);

TweenLite.to(failure, 1, {top: −999, left: 210, ease:

Back.easeInOut});

}
function closeSuccess( ) {

var success = document.getElementById(“success”);

TweenLite.to(success, 1, {top: −999, left: 210, ease:

Back.easeInOut});

}

function showHint( ) {

var hint = document.getElementById(“hint”);
TweenLite.fromTo(hint, 1, {top: 0, left: 210}, {top: 80, left: 210,

```
ease: Back.easeInOut, onComplete: closePopup});
  }
  function closePopup( ) {
```

TweenLite.to(‘.popup’, 1, {top: −999, left: 210, ease:

```
Back.easeInOut});
  }
  </script>
</head>
<body>
```

<!-- CODE WILL BE HERE -->
<div class=“owrapper”>

<div id=“branArea”>

<div class=“nav”>

<div class=“logo”>

<img src=“images/logon.png” />

</div>
<div class=“buttons”>

<!-- div class=“puzzleinfo”>

<p><strong>Category:</strong>

Food</p>

<p><strong>Word in

puzzle:</strong> 4</p>

</div -->
<div class=“countdown”>

<p class=“desc”>Time</p>
<span class=“count”

id=“countdown”>05:00:00</span>

</div>
<div class=“guess”>

<p class=“text”>Guesses</p>
<p class=“guess-count”>5</p>

</div>
<div class=“tag” id=“info”>

<div style=“margin-top: 15px”>Go

go<br />go</div>

</div>

</div>

</div>

</div>
<div id=“failure” class=“failure”

style=“background: url(images/failed_popup.png) no-

repeat; width: 570px; height: 320px; display: block; position: absolute; top:
−9999px;”></div>

<div id=“success” class=“success”

style=“background: url(images/success_popup.png) no-

repeat; width: 570px; height: 320px; display: block; position: absolute; top:
−9999px;”></div>

<div id=“hint” class=“hint popup”

style=“background: url(images/success_popup.png) no-

repeat; width: 570px; height: 320px; display: block; position: absolute; top:
−9999px;”>You

can only use 1 hint per game...</div>

<div class=“bshint”>DO NOT REPEAT BUTTONS ALREADY PLAYED</div>

</div>
<div class=“footer”>

<div class=“lpart”>

<img src=“images/25-logo.png” />

</div>
<div class=“rpart”>

<img src=“images/belcom-logo.png” />

</div>
<div class=“mpart”>

<div class=“mininav”>

<ul>

<li><a href=“”>HOME</a></li>
<li><a href=“”>ABOUT US</a></li>
<li><a href=“”>RULES</a></li>
<li><a href=“”>TERMS &

CONDITIONS</a></li>

<li><a href=“”>REDEMPTION</a></li>
<li><a href=“”>PRIVACY POLICY</a></li>
<li><a href=“”>FAQ</a></li>
<li><a href=“”>CONTACT US</a></li>

</ul>

</div>
<p>

Copyright &copy; 1991 - 2013. Belcom Corp.

Brandoodles is a

registered Trademark of Belcom Corp. All Rights

Reserved.<br />

Brandoodles.com consists of an independent

rewards promotional

program. Belcom Corp and Brandoodles.com<br />

are not affiliated

with any of the branded products or retailers

listed or stated in

the contents herein or any other<br /> Belcom

Corp programs.

Trademarks, service marks, logos, and/or domain

names (including,

without limitation,<br /> individual names of

products and

retailers) are the property of their respective

owners, having no

association<br /> with or make any endorsement

of the products or

services provided by Relcom Corp. or

Brandoodles.com.<br /> If you

have any questions regarding contents please

contact us at: <a

href=“mailto:info@belcomcorp.com”>info@belcomcorp.com</a>.

</p>

</div>

</div>

</body>
</html>

APPENDIX B
Random String Generator Source

```
<html xmlns=“http://www.w3.org/1999/xhtml”>
<head>
  <title>Random alphanumeric string generator</title>
  <meta http-equiv=“Content-Type” content=“text/html; charset=utf-8”/>
```

<meta name=“description” content=“Generate random alphanumeric strings

of numbers, letters and symbols that can be used to create coupon codes,
passwords and other unique identifiers.” />

<meta name=“keywords” content=“alphanumeric strings, numbers, letters,

symbols, true random numbers” />

<link rel=“shortcut icon” href=“images/favicon.ico?v4” />
<base href=“http://www.sweepjudge.com/” />

```
  <link href=“styles.css” rel=“stylesheet” type=“text/css” />
  <link rel=“stylesheet” type=“text/css” href=“css/styles.css?v4” />
```

<script src=“includes/prototype.js” type=“text/javascript”></script>
<script src=“includes/campus.common.js”

type=“text/javascript”></script>

<script src=“includes/login utils.js” type=“text/javascript”></script>
<script src=“includes/random.js” type=“text/javascript”></script>

</head>
<body>

<!--Start header-->
<div id=“header”>

<div id=“header_content”>

<a href=“/” id=“logo”><img src=“img/logo-new.png”

alt=“Third party drawing service”/></a>

<!--Start login-logout-->

<NOBR><a class=“login_logout”

href=“login.htm”><span
class=“stretch_button”><span><span>login</span></span></span></a></NOBR>

<!--End login-logout-->
<div class=“clear”></div>

<table align=“left” cellpadding=“0”

cellspacing=“0” style=“margin-left:6px”>

<tr>
<td>
<!--Start main-menu-->

<ul id=“main_menu”>
<li class=“first”><span><a

href=“index.htm”>Home</a></li><li><span><a
href=“third party drawings.htm”>Third Party Drawings</a></li><li><span><a
href=“public records.htm”>Public Records</a></li><li><span><a
href=“free tools.htm”>Free Randomizer Tools</a></li><li class=“last”><span><a
href=“blog.htm”>Blog</a></li>

</ul>

<!--Start end main-menu-->
</td>
</tr>
</table>

<div class=“clear”></div>

</div>

</div>
<!--End header-->
<!--Start main area-->
<div id=“mainarea”>

<!--Start content-->
<div id=“content”>

<!--Start center-->
<div class=“center-top_angel”>

<div class=“center-bottom_angel”>

<div class=“center”>

<!--Start drawing step4-->
<div

class=“drawing_step4_pages”>

<h1>String

Generator</h1>

<table width=“100%”>
<tr>

<tr>

<td colspan=“3” style=“padding-top:3px;padding-

right:200px;background-image:url(images/random/string-image.jpg);background-
position:top right/background-repeat:no-repeat”>

<p>The form below is a random string generator,

which can be utilized to generate a series of coupon codes, unique passwords
and any other random alphanumeric strings. By entering &quot;L&quot; for
Letters, &quot;N&quot; for Numbers and &quot;S&quot; for Symbols, the string
generator can create strings that are more than 10 characters in length. This
is one of the only random string generators that incorporate the optional use
of symbols to truly make it a complete solution for all of your string needs.
<BR><BR>
To begin generating random strings, simply enter how many Numbers, Letter and
Symbols you would like your string to consist of and select how many strings
you would like to generate
</p>

</td>

</tr>
<tr>

<td colspan=“3” height=“30”>
<div class=“border_div”></div>
</td>

</tr>
<tr>

<td style=“” colspan=“3”>

<h3>String Generator - Form</h3>
<table width=“100%” class=“steps-table”>

<tr>

<td width=“80”>Step 1 -</td>
<td>

Pattern: <input

size=“10” maxlength=“16” type=“text” value=“LL-NNNN” id=“pat” /> (Use: N to
insert random digit, L-to insert random letter)

</td>

</tr>
<tr>

<td>Step 2 -</td>
<td>

Number of records:

<input type=“text” name=“num” value=“10” size=“6” maxlength=“12” id=“num” />

</td>

</tr>
<tr>

<td>Final Step</td>
<td>

<input type=“submit”

value=“Generate” onclick=“makeRequest( )” />

<input type=“submit”

value=“Reset form” onclick=“resetForm( )” />

</td>

</tr>

</table>

</td>

</tr>
<tr>

<td colspan=“3” height=“30”>
<div class=“border_div”></div>
</td>

</tr>
<tr>

<td style=“” valign=“top” colspan=“2”>

<h3>String Generation - Results</h3>
<span id=“results-stub”><br>To generate

results, please fill out the form above </span>

<pre id=“results”></pre>

</td>
</td>
<td width=“500” style=“border-left: 1px solid #D9D9D9;”

valign=“top”>

<div class=“other-random-tools-small-

block”>

<h3>Free Randomizer Tools</h3>

<p><a

href=“lottery.htm”>Lottery Quick Pick</a> is perhaps the Internet's most
popular with over 120 lotteries</p>

<p><a

href=“integer generator.htm”>Number Generator</a> makes random numbers in
configurable intervals</p>

<p><a

href=“password_generator.htm”>Password Generator</a> makes secure passwords
for your Wi-Fi or that extra Gmail account</p>

<p><a

href=“string generator.htm”>String Generator </a>makes random alphanumeric
strings and includes the ability incorporate symbols, much like you would
find when generating coupon codes for your Web site.</p>

</div>

</td>

</tr>
</td>

</tr>

</table>
</div>

<!--End drawing step4-->

</div>

</div>

</div>
<!--End center-->

</div>
<!--End content-->

</div>
<!--End main area-->
<!--Start footer-->
<div id=“footer”>

<div id=“footer_content”>

<ul id=“footer_links”>

<li>Third Party Drawings<br/>

<a

href=“third party drawings.htm”>Overview</a>

</li>
<li>Public Records<br/>

<a

href=“public_records.htm”>Results</a>

</li>
<li>Free Randomizer Tools<br/>

<a href=“integer generator.htm”>Number

Generator</a><br/>

<a

href=“password generator.htm”>Password Generator</a><br/>

<a href=“string generator.htm”>String

Generator</a><br/>

<a href=“lottery.htm”>Lottery

Generator</a><br/>

</li>
<li>About SweepJudge<br/>

<a href=“contactus.htm”>Contact

Us</a><br/>

<a href=“faq.htm”>FAQ's</a><br/>
<a

href=“third party drawings tac.htm”>Terms &#38; Conditions</a><br/>

<a href=“policy.htm”>Privacy

Policy</a><br/>

</li>
<li>Partners<br/>

<a target=“_blank”

href=“http://www.cityopoly.com”>Cityopoly</a><br/>

<a target=“_blank”

href=“http://www.brollytime.com”>Rain umbrellas</a><br/>

</li>

</ul>
<a href=“/” id=“footer_logo”><img

src=“img/footer_logo.png” alt=“Random number service”/></a>

<div class=“clear”></div>
<p class=“copyright”>&#169; 2013 SweepJudge.com All

Rights Reserved</p>

</div>

</div>
<!--End footer-->

```
<script type=“text/javascript”>
  var AJAXBaseURL = ‘http://www.sweepjudge.com’;
  var AJAXSessionParam =
```

‘&PHPSESSID=uj82aiq4u718lvpipck20hg627’;

var AJAXSessionID = ‘uj82aiq4u718lvpipck20hg627’;
</script>
<div id=“campus_popup_overlay”></div>

```
<div id=“campus-custom-popup” style=“display:none”>
  <div id=“campus-custom-popup-html” style=“float:left;width:92%”>
  </div>
  <div style=“float:right;width:25px;”>
  <a href=“javascript:;” id=“campus-custom-popup-close-btn”
onclick=“closeCustomModalDialog( );return
false;”style=“background:none;padding:5px; padding-right:10px;”><img
src=“http://www.sweepjudge.com/images/close.gif” border=“0”></a>
  </div>
</div>
<div id=“campus-custom-tooltip” style=“display:none”>
  <div id=“campus-custom-tooltip-html”></div>
</div>
<script src=“includes/ut.util.js” type=“text/javascript”></script>
<script type=“text/javascript”>
  var _gaq = _gaq || [ ];
  _gaq.push([‘_setAccount’, ‘UA-37565783-1’]);
  _gaq.push([‘_trackPageview’]);
  (function( ) {
    var ga = document.createElement(‘script’); ga.type = ‘text/javascript’;
ga.async = true;
    ga.src = (‘https:’ == document.location.protocol ? ‘https://ssl’ :
‘http://www’) + ‘.google-analytics.com/ga.js’;
    var s = document.getElementsByTagName(‘script’)[0];
s.parentNode.insertBefore(ga, s);
  })( );
</script>
```

</body>

</html>
<script src=“includes/strings.random.js” type=“text/javascript”></script>

Strings.random.js

function resetForm( )
{

$(‘pat’).value = ‘NN-LLLL’;
$(‘len’).value = 10;

}
function makeRequest( )
{

var num = $(‘num’).value;
var pat = $(‘pat’).value;
var code = ‘’;
new

Ajax.Request(‘/ajax/strings.php?pat=’+pat+‘&num=’+num+‘&contactCheck=’+code,

{

method:‘get’,
onSuccess: function(transport)
{

var response = transport.responseText || “Wrong

parameters”;

$(‘results-stub’).hide( );
CMPS_SetBlinkingText($(‘results’),response);

},
onFailure: function( )
{

alert(‘Error! Something went wrong...’)

}

});

}

The embodiment of the invention in which an exclusive property or privilege is claimed is defined as follows:

1. A method for promoting sales and increasing brand recognition comprising:
a. selecting brand names of products based on customer purchases enumerated on a customer receipt generated at a retail outlet;
b. obfuscating one of said brand names on the customer receipt so as to induce a customer to attempt to guess the one of said brand name; and
c. determining if the customer guessed correctly.

2. The method as recited in claim 1 wherein the step of obfuscating one of said brand names further comprises eliminating letters of the brand name, or jumbling the order of the letters of the brand name or a combination thereof.

3. The method as recited in claim 1 wherein the selection of brand names is based on inventory levels of items available for purchase at the retail outlet or redeemed online with a smart phone or other intelligent device, or upon presentation in person with a printed document detailing the description of the redemption.

4. The method as recited in claim 1 wherein the selection of brand names favors brands with lower sales levels.

5. The method as recited in claim 1 wherein the game piece requires the customer to complete a selected brand name by supplying missing letters.

6. The method as recited in claim 1 wherein the receipt piece includes a unique identifier string.

7. The method as recited in claim 6 wherein the customer provides the completed brand name along with the unique identifier string to an administrator which verifies the accuracy of the customer's guess.

8. The method as recited in claim 7 wherein the administrator selects a prize for accurate submissions, and the administrator notifies the customer of the prize.

9. The method as recited in claim 1 wherein the customer receipt indicates an association with a brand-name guessing game.

10. The method as recited in claim 6 wherein the unique identifier string is selected from a plurality of unique identifier strings associated with the brand name guessing game.

11. A brand-name promotional system, the system comprising:
a. point of sale scanner for recording customer purchases at a retail outlet;
b. means for identifying product classes based on the customer purchases;
c. game piece generator for printing indicia onto a customer receipt; wherein the indicia is an obfuscated brand name, wherein the brand name identifies goods found in the product classes; and
d. means for determining if a customer correctly guesses the brand name from the indicia.

12. The system as recited in claim 12 wherein the game piece generator prints a unique alpha numeric character string on the customer receipt.

13. The system as recited in claim 13 wherein the determining means utilizes the character string to identify the retail outlet from where the customer made the purchases.

14. The system as recited in claim 11 wherein the brand name is selected by an off site administrator.

15. The system as recited in claim 14 wherein the off site administrator notifies the retail outlet of the customer guesses.

16. The system as recited in claim 11 wherein the brand name is selected by a brand manager at the retail outlet.

17. The system as recited in claim 12 wherein the determining means comprises an internet portal that the customer logs into using the alpha numeric character string.
